(19) United States
(12) Patent Application Publication
(10) Pub. No.: US 2004/0106517 A1
(43) Pub. Date: Jun. 3, 2004

(54) Chemicals from synthesis gas

(76) Inventors: Thulani Humphrey Dlamini, Sasolburg (ZA); Rafael Luis Espinoza, Sasolburg (ZA); Genevieve Joorst, Sasolburg (ZA); Masikana Millan Mdleleni, Sasolburg (ZA); Jacobus Lucas Visagie, Sasolburg (ZA)

Correspondence Address: INDIANAPOLIS OFFICE 27879, BRINKS HOFER GILSON & LIONE, ONE INDIANA SQUARE, SUITE 1600, INDIANAPOLIS, IN, 46204-2033, US

(21) Appl. No.: 10/296,310

(22) PCT Filed: May 23, 2001
(86) PCT No.: PCT/IB01/00904

(30) Foreign Application Priority Data
May 23, 2000 (ZA) 2000/2549

(51) Int. Cl. B01J 23/40

(52) U.S. Cl. 502/326; 502/329; 502/331

(57) ABSTRACT

This invention relates to an iron-based Fischer-Tropsch cataylst composition wherein the iron phase is ferrihydrite. The catalyst composition optionally includes a structural promoter which may be selected from manganese or chromium or a mixture thereof and chemical promoters selected from magnesium, zinc, copper and an alkaline or alkali metal such as potassium. The catalyst is best bound to a refractory oxide support such as silica. This catalyst composition produces significant yields of higher parafins, olefins and alcohols.

### BACKGROUND TO THE INVENTION

This invention relates to iron-based catalysts and in particular to iron-based catalysts and their use in the conversion of synthesis gas (CO and H₂) to alcohols and olefins.

Research into the production of an alternative feedstock for chemicals has escalated in the past decade due mainly to decreasing petroleum reserves as well the increasing instability of international hydrocarbon sources. This resurgence in the research in this area has lead to the realization that the Fischer-Tropsch process can be utilized to synthesize a hydrocarbon product that consists mainly of olefins and linear alcohols with carbon number distribution from ˜C₁-C_{22.}

The Fischer-Tropsch process involves the hydrogenation of CO in the presence of Group VII metals such as Fe, Co, Ru, etc. In general the products formed from this reaction are gaseous and liquid hydrocarbons as well as oxygenates that include, inter alia, olefins and higher paraffins. The chain length of these products is determined by the well-known Anderson-Schulz-Flory distribution. There is extensive information in both the open and patent literature on the formulation of catalysts for this process. However, the use of these known catalyst formulations in this process does not provide for a close control of the product spectrum, especially in the production of C₂-C₂₂ alpha olefins and linear alcohols. To achieve this goal would require extensive modification of the formulation of the current Fischer-Tropsch catalyst. A number of patents for example U.S. Pat. No. 4,639,431; U.S. Pat. No. 4,624,967; U.S. Pat. No. 4,604,375, U.S. Pat. No. 5,100,856, GB 2, 151, 500 A, US 621, 102 describe processes for the manufacture of olefins with a molecular weight range that renders them suitable for the production of fine chemicals such as detergents and plasticizers. Catalysts described in the prior art are mostly based on spinel-type structures with low surface area.

Other disclosures in the prior art, CA 1,305,189; EU 0 355 229 and ZA 98/8726 relate to the production of α-olefins and alcohols from H₂ and CO₂, in the presence of a catalyst. For example, ZA 98/8726 relates to the production of olefins and alcohols using a promoted Co based catalyst, prepared from metals oxalates. The catalyst prepared in this manner has a surface area of 5 m²/g and produces a significant amount of methane.

The processes described in the prior art mentioned above emphasize the optimization of the catalyst formulation and reaction conditions for the production of olefins as the main product. Despite the disclosures in the prior art there remains a need for the development of a catalyst that will under Fischer-Tropsch conditions selectively produce a hydrocarbon product that consists of alcohols and olefins as major products.

### SUMMARY OF INVENTION

This invention relates to iron based catalysts and in particular to iron-based catalysts and their use in the conversion of synthesis gas (CO and H₂) to alcohols and olefins in a Fischer-Tropsch process.

According to a first aspect of the invention there is provided an iron-based Fischer-Tropsch catalyst composition wherein the main iron phase is ferrihydrite. By “iron-based” is meant that Fe makes up at least 30% (by mass) of the composition. The term “the main iron phase is ferrihydrite” means that at least 75% of the iron phase is ferrihydrite, as determined by X-ray diffraction using Co K alpha radiation. The preferred catalyst compositions exhibit hyperfine interaction parameters similar to those of ferrihydrite, as determined by Mossbauer absorption spectroscopy (MAS).

The iron-based catalyst composition optionally also comprises a structural promoter selected from Mn, Cr or a mixture thereof. Preferably, the iron-based catalyst composition also comprises a chemical promoter or promoters selected from Zn, Mg, Cu, Ru, Pd, Rh and/or an alkali or alkaline earth metal such as K.

A “structural promoter” is a chemical species/element that helps to stabilize the ferrihydrite phase of the catalyst. A “chemical promoter” is a chemical species/element that alters the product selectivity and activity of a catalyst.

Advantageously, the iron-based catalyst composition has a surface area from 50 to 200 m²/g, typically from 100 to 200 m² μg, as determined by the BET surface area measurement technique.

Preferably, the iron-based catalyst composition includes Cu and K and optionally Mn promoters.

The iron-based catalyst composition is best bound with a refractory oxide which may be selected from silica, alumina or silica-alumina, preferably silica.

The iron based catalyst composition may, by mass of the composition, comprise:

35%-60% Fe, preferably 45%-60% Fe

0%-15% Mn, preferably 7%-15% Mn

3%-10% Zn, preferably 3%-7% Zn

0.5%-2% Cu, preferably 0.5%-1%; and

0.5%-2% K₂O, preferably 0.5%-1% K₂O.

When bound with silica, the iron-based catalyst composition typically contains, by mass of the composition, 1%-30% silica.

The bound iron-based catalyst composition typically has a surface area of 100 to 300 m²/g, as determined by the BET surface area measurement technique.

Advantageously, the iron-based catalyst composition comprises Zn, Mn, Cu and K in the following ranges of mass ratios, relative to the iron:

Fe:Zn 2:1 to 100:1, preferably 8:1

Fe:Mn 2:1 to 4:1, preferably 4:1

Fe:Cu 10:1 to 60:1, preferably 50:1

Fe:K₂O 15:1 to 200:1, preferably 50:1.

The iron-based catalyst composition may further comprise other materials such as promoters, activators, spacers, carriers, diluents and supports. These other materials may include zeolites, pulverized borosilicate glass, pulverized quarts, kieselguhr, silicon carbide, Group II to VII oxides and rare earth oxides including but not limited to MgO, Al₂O₃, TiO₂, ThO₂, Cr₂O₃, MnO, ZrO₂, La₂O₃ and CeO₂.

According to a second aspect of the invention there is provided a process for preparing an iron-based catalyst composition wherein the main iron phase is ferrihydrite, the process including precipitation of Fe ions from a solution of a polar solvent in the presence of a precipitating agent, followed by drying and calcination of the catalyst.

Typically, the process includes the following steps:

1) preparing a solution in a polar solvent, the solution containing Fe ions;

2) adding a precipitation agent, typically a base, to the solution to form a precipitate wherein the main iron phase is ferrihydrite;

3) washing the precipitate to remove excess sodium, ammonium and potassium nitrates;

4) drying, typically spray-drying, the washed precipitate;

5) calcining the dried precipitate in a fluidized bed, fixed bed, furnace, rotary kiln and/or torbed calcina to obtain calcined catalyst particles with particle sizes ranging from 20 to 250 μm; and

6) binding the dried precipitate with a refractory metal oxide;

7) optionally, instead of calcining the dried catalyst at step 5, the washed precipitate from step 4 may be slurried and bound with a refractory oxide and calcined.

Step 1 may comprise dissolving metal precursors, except a Fe(II) precursor, in a polar solvent to form a first solution; dissolving a Fe(II) precursor in a dilute mineral acid to form a second solution; and mixing the first and second solutions to form the solution containing Fe ions.

Conveniently, the first solution is formed by dissolving a ferric salt, such as iron nitrate, in the polar solvent.

In a preferred embodiment of the invention the polar solvent is water, the dilute mineral acid is dilute HNO₃, and the base is selected from aqueous NH₃, KOH or NaOH.

Structural promoters and chemical promoters may be included in the composition in Step 1, or by impregnation after Step 2.

The structural promoters may be selected from Mn, Cr or a mixture thereof and the chemical promoters may be selected from Zn, Mg, Cu, Cr, Ru, Pd, Rh, an alkaline or alkali earth metal such as K.

Preferably, the structural and chemical promoters are included in the composition in Step 1, by adding the salt of the promoter, for example, by adding manganese nitrate for Mn, zinc nitrate for Zn, copper nitrate for Cu and potassium nitrate for K, to the polar solvent of the first solution.

Preferably, Step 2 is achieved by precipitation from an acidic aqueous solution of Fe(III) nitrate and/or, Fe(II) oxalate, optionally manganese nitrate, zinc nitrate, copper nitrate, and potassium nitrate using a basic solution of aqueous NH₃, NaOH or KOH as a precipitating agent.

Where manganese nitrate is not included in the aqueous solution, the base KOH should be used instead of aqueous NH₃ to ensure that the main iron phase is ferrihydrite.

Step 2 may be carried out at a constant or a variable ascending (from 1 to 12) or descending (from about 12 to 1) pH (by titrating the acidic solution with the basic solution or vice versa), preferably at a constant pH in the range of 6-9, most preferably at a pH of about 8±0.2.

Advantageously, Step 2 is carried out at a high temperature of from 40° C. to 90° C., preferably from 50° C. to 70° C., to ensure that the main iron phase is ferrihydrite.

In Step 4, the catalyst may be spraydried at temperatures of about 120° C. The catalyst obtained after spray-drying typically consists of spherical particles with a size ranging from 40 to 150 μm.

In Step 5 or Step 7, the catalyst is typically calcined in air at a temperature between 250 and 500° C. for 5-20 hours.

In Step 5, the catalyst is preferably calcined in air at a temperature of 450° C. for 16 hours and in Step 6 the catalyst is preferably calcined in air at a temperature of 400° C. for 5 hours.

In Step 6, the calcined product is ground and bound with 1 to 30% (by mass of the composition) of silica and the resulting mixture is homogenized and dried to obtain a silica bound iron-based catalyst.

In Step 7, the dried catalyst is slurried and bound with silica, and calcined to provide a bound iron-based catalyst composition comprising 1 to 30% (by mass of the composition) silica.

According to a third aspect of the invention there is provided a process for producing higher parafins, alcohols and olefins selectively, by reacting hydrogen with carbon monoxide in the presence of a catalyst substantially as described herein above. In a preferred embodiment of the invention there is provided a process for producing linear parafins, alcohols and olefins selectively.

The process for producing parafins, alcohols and olefins selectively may be a Fischer-Tropsch process at pressure between 10 and 100 bar (1 and 10 MPa), preferably at about 20 bar (2 Mpa), within a temperature range between 200 and 310° C., preferably between 220 and 250° C., most preferably at 240° C.

### DETAILED DESCRIPTION OF PREFERRED EMBODIMENTS

In broad terms this invention relates to a catalyst composition for, and method of, selectively converting synthesis gas under Fischer-Tropsch conditions (at pressures of 20 to 100 bar (2 to 10 MPa) and low temperatures of 200 to 310° C.) to paraffins, olefins and, more especially, to linear alcohols in significant yields, up to and including detergent alcohols.

Catalyst compositions according to preferred embodiments of the invention are iron-based and the main iron phase is ferrihydrite. The catalyst composition optionally includes a structural promoter which may be selected from manganese or chromium or a mixture: thereof and chemical promoters selected from magnesium and zinc, preferably manganese and zinc, in one matrix. In addition, the matrix of the catalyst composition also includes and is dually promoted with copper and an alkaline or alkali metal such as potassium and is bound to a metal oxide support such as silica.

The amount of the compounds of the metals Fe, Mn, Zn, Cu and K are selected so that, in the matrix, the metals have the following ranges of mass ratio, relative to the iron:

Fe:Zn of 2:1 to 10:1

Fe:Mn 2:1 to 4:1

Fe:Cu of 10:1 to 60:1

Fe: K2O of 15:1 to 200:1.

In this embodiment of the invention, a precursor for Fe(III) (Iron nitrate), is dissolved with compounds of copper (Cu(NO₃)₂), manganese (Mn(NO₃)₂) and potassium (KNO₃) in a polar solvent, namely water, to form a first solution. A precursor for Fe(II) containing conjugate bases of carboxylic acid as ligands, in this embodiment ferrous oxalate (FeC₂O₄.2%2O), is dissolved in a dilute nitric acid solution to form a second solution. The two solutions are then mixed to provide a mole ratio of iron atoms from the 2^{nd} solution to those from the 1^{st} solution of 1:2. A basic precipitating agent, aqueous NH₃, is added at a temperature of 50° C. and precipitation is achieved at a pH of 8.2. Rapid simultaneous precipitation by vigorous stirring is preferred. The precipitate so formed is centrifuged and dried at 120° C. to give a reddish-brown product which is calcined at 400° C. for 5 hours to yield a reddish calcined product. The calcined product is mixed with 25% (m/m) SiO₂ and dried at about 120° C. to form a bound iron-based catalyst. Mössbauer and X-ray diffraction analysis of this catalyst revealed that the main iron phase is ferrihydrite (Fe₅HO₈.4H₂O) with a surface area of 149.5 m²/g, as determined by the BET surface area measurement technique.

The above method of catalyst preparation can be used to prepare catalysts with different ratios of Fe(II) to Fe(III). Table I below provides a summary of the data obtained from the characterization of these catalysts.

TABLE I

| Ca- | Fe(II) to Fe(III) | Surface area | Total pore | Crystallographic |
|---|---|---|---|---|
| talyst | mole ratio | (m²/g) | volume (cm³/g) | Phase |
| A | 1:4 | 165.2 | 0.17 | Ferrihydrite |
| B | 1:2 | 149.5 | 0.21 | Ferrihydrite |
| C | 1:1 | 154.8 | 0.18 | Ferrihydrite |
| D | 3:2 | 151.7 | 0.15 | Ferrihydrite |
| E | 2:1 | 162.5 | 0.14 | Ferrihydrite |

It is believed that the Mn (or Cr or a mixture of Cr and Mn) acts as a structural promoter that helps to stabilize the ferrihydrite structure of the catalyst. It is also believed that Zn and Mg are chemical promoters that enhance the selective production of alcohols, Cu (or Ru, Pd or Rh) is a chemical promoter that helps to enhance reduction, and K (or other alkali metals or alkali earth metals) is a chemical promoter that enhances the selective production of olefins, and also enhances hydrocarbon chain growth during a Fischer-Tropsch reaction.

In a comparative example, the catalyst was prepared using aqueous NH₃ as the precipitating agent, but omitting a compound for manganese from the first solution. The catalyst formed by this method did not consist of ferrihydrite, but consisted of hematite and had low surface area of only 27 m²/g. The activity of this comparative catalyst is discussed below.

In another embodiment of the invention, the catalyst was prepared omitting a compound for manganese from the first solution, but using KOH as the precipitating agent. The catalyst formed by this method is an iron based composition wherein the main iron phase is ferrihydrite and had a surface area of 125 m²/g.

According to yet a further embodiment of the invention, a catalyst according to the invention was prepared by including a compound for manganese in the first solution, and using KOH as the precipitating agent. The catalyst formed by this method is an iron based composition wherein the main iron phase is ferrihydrite and had a surface area of 102 m²/g.

Although the calcination step in the first embodiment of the invention mentioned above takes place prior to binding the iron-based catalyst to a support, the calcination process can take place after binding the catalyst to a support. In this case, the precipitate is washed, and the reddish brown cake obtained upon filtration is reslurried and bound with 25% (m/n) silica support and the resulting slurry spraydried at 120° C. to provide particles with a diameter ranging from 20 to 250 μm. The resulting brown iron-based catalyst was then calcined at 450° C. for 16 hours.

Although the structural and chemical promoters in the above-mentioned embodiments of the invention are included in the solutions from which the precipitate is made, one or more of the promoters may be impregnated into the iron-based catalyst, after the precipitation stage.

It should also be noted that although the iron-based catalyst compositions of the invention are bound to silica, unbound catalysts may also be used.

An unbound iron-based catalyst composition would also have a high surface area of 50 to 200 m²/g, typically 100 to 200 m²/g, as determined by the BET surface area measurement technique.

A Fischer-Tropsch synthesis process according to an embodiment of the invention is carried out with an iron-based catalyst composition according to the invention as described above in a slurry bed reactor containing a crude synthetic paraffin or wax liquid with a carbon chain length varying from C₁₀ to C₁₂₀, such as the wax obtained from a slurry bed reactor process, using either Fe or Co based catalysts. An iron-based catalyst composition as described above is then suspended in the slurry medium, the catalyst loading ranging between 10 and 40% by weight of the slurry. The slurry is stirred and conditioned by causing pure H₂, CO or a hydrogen rich H₂/CO mixture to flow continuously through the medium for approximately 20 hours. Alternatively, catalyst conditioning (that is reduction and carbiding) may be carried out at atmospheric pressure using H₂, CO or H₂/CO. Thereafter, synthesis gas is caused to flow continuously through the conditioned slurry. The composition of the synthesis gas feed generally comprises H₂ and CO in an H₂:CO molar ratio in the range of about 5:1 to about 1:5, preferably in the range of about 1:1 to 2:1. The feed synthesis gas may also comprise about 1 to 25 volume percent CO₂, N₂, and or CH₄. Throughout the conditioning process and synthesis process, the reactor is operated at a temperature between 200 and 310° C.; preferably between 220 and 250° C., most preferably at about 240° C.; and pressure between 10 and 100 bar (1 and 1.0 MPa).

The iron-based catalyst compositions wherein the main iron phase is ferrihydrite of the present invention produce significant yields of alcohols which are characterized by up to about 90% linearity at reactor pressure values of between 20 to 100 bar (2 to 10 MPa). The results have shown that under the pressure and temperature synthesis conditions according to invention, the total yield of alcohols in the cold condensate alone may be in excess of 30% typically 40% by mass. The linear alcohols include plasticizer alcohols, i.e. medium chain alcohols in the C₅ to C₉ range and also detergent alcohols, i.e. long chain alcohols in the C₁₀ to C₂₂ range.

The iron-based catalyst compositions of the invention wherein the main iron phase is ferrihydrite show improved catalytic performance over the iron-based catalysts that consist of hematite as can be seen by the percent CO converted to hydrocarbons in Table 3. The iron-based catalyst compositions wherein the main iron phase is ferrihydrite also show low selectivity for the formation of methane (which is an undesirable product) as can be seen by the percentage conversion of CO to methane in Table 3. Furthermore, the iron-based compositions of the invention show good selectivity towards the higher parafins, alcohols and olefins, as can be seen from the composition of the C8+ fraction and the product yield for the C8+ fraction and also the α-value of the C₆-C₁₂ product faction in Table 3.

The invention will now be further described by means of the following non-limiting Examples.

### EXAMPLE 1

An aqueous solution was prepared by dissolving 85.3 g of Fe(NO₃)₃.9H₂O, 1.2 g Cu(NO₃)₂.4H₂O, 13.4 g Zn(NO₃)₂.3H₂O, 6.7 g Mn(NO₃)₂.4H₂O and 0.72 g KNO₃ in 400 mL H₂O. This solution was co-fed rapidly with a 25% aqueous NH₃ solution into a vigorous stirred precipitation vessel at 50° C. The flow rates of the two solutions were adjusted such that a precipitate was formed at a constant pH of 9. The precipitate was centrifuged, the supernatant decanted, dried at 120° C. and then calcined at 400° C. for 5 hours. The calcined catalyst was ground and bound with 25% (m/m) SiO₂ prior to testing in a slurry phase reactor. This catalyst is herein referred to as Ex1.

### EXAMPLE 2

An aqueous solution was prepared by dissolving 56.5 g of Fe(NO₃)₃.9H₂₀, 1.2 g Cu(NO₃)₂.4H₂O, 13.4 g Zn(NO₃)₂.3H₂O, 6.7 g Mn(NO₃)₂.4H₂O and 0.72 g KNO₃ in 400 mL H₂O. In another vessel 12.6 g FeC₂O₄.2H₂O was dissolved in 140 mL of 3.5 M HNO₃. The two solutions were mixed thoroughly. The resulting solution was then co-fed rapidly with a 25% aqueous NH₃ solution into a vigorously stirred precipitation vessel at ˜50° C. The flow rates of the metal salts solution and aqueous NH₃ were adjusted such that a precipitate was formed at a constant pH of ˜9. The precipitate was centrifuged, the supernatant decanted, dried at 120° C. to give a reddish-brown precipitate, which was calcined at 400° C. for 5 hours to yield a black brittle precipitate. The calcined catalyst was ground and bound with 25% (m/m) SiO₂ before it was tested in a slurry phase reactor. This catalyst is herein referred to as Ex2.

### COMPARATIVE EXAMPLE 3

A catalyst similar to the one presented in Example 2 was prepared without Mn. This entailed prepared an aqueous solution of 56.5 g of Fe (NO₃)₃.9H₂₀, 1.2 g Cu(NO₃)₂.4H₂O, 13.4 g Zn(NO₃)₂.3H₂O, 6.7 g and 0.72 g KNO₃ in 400 ml. H₂O. Separately 12.6 g FeC₂O₄.2H₂O was dissolved in a solution 140 ml 3.5 M HNO₃. These two solutions were mixed thoroughly and then co-fed rapidly with a 25% aqueous NH₃ solution into a vigorously stirred precipitation vessel at ˜50° C. The flow rates of the two solutions were adjusted such that a precipitate was formed at a constant pH of ˜9. The precipitate was centrifuged, the supernatant decanted, dried at 120° C. and then calcined at 400° C. for 0.5 hours. This catalyst is herein referred to as Ex3.

### EXAMPLE 4

An aqueous solution of Fe, Zn, and Cu was prepared by dissolving 1447 g of Fe (NO₃)₃.9H₂O, 22.8 g Cu(NO₃)₂.4H₂O, and 170.5 g Zn(NO₃)₂.3H₂O, in 4000 ml H₂O. In another vessel 322.1 g FeC₂O₄.2H₂O was dissolved in 1000 mL of 10 M HNO₃: The two solutions were mixed thoroughly. The resulting solution was heated to 70° C. In another vessel, a 25% aqueous KOH solution was heated to 40° C. The hot solutions were then co-fed rapidly into a vigorously stirred precipitation vessel at ˜70° C. The flow rates of the two solutions were adjusted such that a precipitate was formed at a constant pH of ˜8. The precipitate was filtered and washed with distilled water at room temperature. The reddish brown cake obtained upon filtration was reslurried and bound by adding silica sol. The resulting slurry was spray dried at about 120° C. to give spherical particles with diameter ranging from 20 to 250 μm. The dried catalyst was calcined in air at 450° C. for 16 hours. This catalyst is herein referred to as Ex4.

### EXAMPLE 5

An aqueous solution of Fe, Mn, Zn, and Cu was prepared by dissolving 1447 g of Fe (NO₃)₃.9H₂O, 342.6 g Mn(NO₃)₂.4H₂O, 22.8 g Cu(NO₃)₂.4H₂O, and 170.5 g Zn(NO₃)₂.3H₂O, in 4000 ml H₂O. In another vessel 322.1 g FeC₂O₄.2H₂O was dissolved in 1000 mL of 10 M HNO₃. The two solutions were mixed thoroughly and the resulting solution was heated to 70° C. In another vessel, a 25% aqueous KOH solution was heated to 40° C. The hot solutions were then co-fed rapidly into a vigorously stirred precipitation vessel at ˜70° C. The flow rates of the two solutions were adjusted such that a precipitate was formed at a constant pH of ˜8. The precipitate was filtered and washed with distilled water at room temperature. The reddish brown cake obtained upon filtration was reslurried and bound by adding silica sol to contain 10% (m/m) SiO₂. The resulting slurry was spray dried at about 120° C. to give spherical particles with diameter ranging from 20 to 250 μm. The dried catalyst was calcined in air at 450° C. for 16 hours. This catalyst is herein referred to as Ex5.

### EXAMPLE 6

The catalysts of Examples 1 to 5 were characterized by X-Ray diffrication and Müssbauer spectroscopy. The surface area (determined by the BET surface area measurement technique) and elemental composition of the catalysts were also recorded. The results are listed in Table 2 below.

Fractions of the catalysts presented in Examples 1 to 5 were sieved between 38-150 μm and then loaded in a stainless steel slurry bed reactor containing 120 g of molten wax. The catalyst slurry was stirred and then conditioned in pure hydrogen at 20 bar (2 Mpa) and 240° C. for 16 hours. Fischer-Tropsch synthesis was initiated by replacing hydrogen with synthesis gas (H₂: CO˜2), at the end of the 16-hour reduction period. Results of these Fischer-Tropsch synthesis tests which show the activity and selectivity data for the catalysts are given in Table 3 below.

TABLE 2

| | Ex. 1 | Ex. 2 | Ex. 3 | Ex. 4 | Ex. 5 |
|---|---|---|---|---|---|
| Precipitating Agent | NH₄OH | NH₄OH | NH₄OH | KOH | KOH |
| Elemental Composition: | | | | | |
| Mn / 100 g Fe | 9.2 | 13.5 | 0 | 0 | 23.2 |
| Zn / 100 g Fe | 5.2 | 6.2 | 5.5 | 10.1 | 10.1 |
| Cu / 100 g Fe | 0.7 | 0.7 | 0.6 | 2 | 2.2 |
| K₂O / 100 g Fe | 0.7 | 0.9 | 0.7 | 1.4 | 1.9 |
| SiO₂ / 100 g Fe | 20 | 20 | 20 | 10 | 10 |
| Main Phase Composition | Ferrihydrite | Ferrihydrite | Hematite | Ferrihydrite | Ferrihydrite |
| Surface area / m²g⁻¹ | 180 | 149.5 | 27.2 | 125 | 102 |

TABLE 3

| | Ex. 1 | Ex. 2 | Ex. 3 | Ex. 4 | Ex. 5 |
|---|---|---|---|---|---|
| % CO converted to HC | 21.0 | 19.2 | 8.2 | 27.1 | 16.9 |
| GHSV / ml(gcat h)⁻¹ | 3067 | 3081 | 3071 | 3610 | 290 |
| Pressure / bar | 20 | 20 | 20 | 45 | 45 |
| Temperature / K | 510 | 511 | 513 | 513 | 513 |
| Reactor partial pressure of: | | | | | |
| H₂ | 8.5 | 8.6 | 8.9 | 20.4 | 22.0 |
| CO | 3.5 | 3.4 | 4.2 | 4.3 | 6.2 |
| CO₂ | 0.6 | 0.5 | 0.2 | 1.5 | 3.2 |
| H₂O | 0.4 | 0.6 | 0.2 | 4.2 | 2.7 |
| Composition of C2-C7 | | | | | |
| fraction / C %: | | | | | |
| C2-C7 paraffins | 29.3 | 27.1 | | 29.7 | 33.7 |
| C2-C7 olefins | 48.5 | 52.1 | — | 42.7 | 37.6 |
| C2-C7 alcohols | 13.2 | 15.4 | — | 21.5 | 23.2 |
| Composition of C8+ | | | | | |
| fraction/C % | | | | | |
| C8+ Paraffins | 31.5 | 36.2 | 31.8 | 37.4 | 33.1 |
| C8+ Olefins | 14.3 | 16.8 | 13.8 | 19.5 | 13.1 |
| C8+ Alcohols | 38.1 | 32.3 | 45.0 | 32.2 | 41.3 |
| Product Yield for the | | | | | |
| C8+ fraction | | | | | |
| C8+ Paraffins | 0.066 | 0.069 | 0.026 | 0.10 | 0.056 |
| C8+ Olefins | 0.030 | 0.038 | 0.011 | 0.014 | 0.022 |
| C8+ Alcohols | 0.080 | 0.062 | 0.037 | 0.087 | 0.070 |
| Alpha value (α) of | — | 0.67 | 0.60 | 0.73 | 0.70 |
| C6-C12 product fraction | | | | | |
| % CH₄ / C % | 14.5 | 9.8 | 17.3 | 5.9 | 9 |

1. An iron-based Fischer-Tropsch catalyst composition wherein the main iron phase is ferrihydrite.

2. An iron-based catalyst composition according to claim 1 which includes a structural promoter selected from Mn, Cr or a mixture thereof.

3. An iron-based catalyst composition according to claim 1 or 2 which includes a chemical promoter or promoters selected from Zn, Mg, Cu, Ru, Pd, Rh and/or an alkali or alkaline earth metal.

4. An iron-based catalyst composition according to claim 3 wherein the alkali earth metal is K.

5. An iron-based catalyst composition according to any one of the preceding claims with a surface area from 50 to 200 m²/g, as determined by the BET surface area measurement technique.

6. An iron-based catalyst composition according to claim 5 with a surface area of from 100 to 200 m²g.

7. An iron-based catalyst composition according to claim 1 including Cu and K promoters.

8. An iron-based catalyst composition according to claim 7 including an Mn promoter.

9. An iron-based catalyst composition according to any one of claims 1-4, 6, 7 or 8 bound with a refractory oxide.

10. An iron-based catalyst composition according to claim 9 wherein the refractory oxide is selected from silica, alumina or silica-alumina.

11. An iron-based catalyst composition according to claim 10 wherein the refractory oxide is silica.

12. An iron-based catalyst composition according to claim comprising, by mass of the composition:
35%-60% Fe,
0%-15% Mn,
3%-10% Zn,
0.5%-2% Cu,
0.5%-2% K₂O.

13. An iron-based catalyst composition according to claim 12 comprising, by mass of the composition:
45%-60% Fe,
7%-15% Mn,
3%-7% Zn,
0.5%-1% Cu, and
0.5%-1% K₂O.

14. An iron-based catalyst composition according to claim 12 containing, by mass of the composition, 1%-30% silica.

15. An iron-based catalyst composition according to claim 14 with a surface area of 100 to 300 m²/g, as determined by the BET surface area measurement technique.

16. An iron-based catalyst composition according to claim 1 comprising Zn, Mn, Cu and K in the following ranges of mass ratios, relative to the iron:
Fe:Zn 2:1 to 100:1,
Fe:Mn 2:1 to 4:1,
Fe:Cu 10:1 to 60:1,
Fe:K₂O 15:1 to 200:1.

17. An iron-based catalyst composition according to claim 16 comprising Zn, Cu and K in the following ranges of mass ratios, relative to the iron:
Fe:Zn 8:1,
Fe:Mn 4:1,
Fe:Cu 50:1,
Fe:K₂O 50:1.

18. A process for preparing an iron-based catalyst composition which consists mainly of ferrihydrite, the process including precipitation of Fe ions from a solution of a polar solvent in the presence of a precipitating agent, followed by drying and calcination of the catalyst.

19. A process according to claim 18 including the following steps:
1) preparing a solution in a polar solvent, the solution containing Fe ions;
2) adding a precipitation agent to the solution to form a precipitate where most of the Fe atoms are present as ferrihydrite;
3) washing the precipitate;
4) drying the washed precipitate;
5) calcining the dried precipitate; and
6) binding the dried precipitate with a refractory oxide;
7) optionally, instead of calcining the dried catalyst at step 5, the washed precipitate from step 4 may be slurried and bound with a refractory oxide and calcined.

20. A process according to claim 19 wherein Step 1 comprises dissolving metal precursors, except a Fe(II) precursor, in a polar solvent to form a first solution; dissolving a Fe(II) precursor in a dilute mineral acid to form a second solution; and mixing the first and second solutions to form the solution containing Fe ions.

21. A process according to claim 20 wherein the first solution is formed by dissolving a ferric salt.

22. A process according to claim 21 wherein the ferric salt is iron nitrate.

23. A process according to any one of claims 20-22 wherein the polar solvent is water and the dilute mineral acid is dilute HNO₃.

24. A process according to any one of claims 19-23 wherein in Step 2 the precipitation agent is selected from aqueous NH₃, KOH or NaOH.

25. A process according to any one of claims 19-24 wherein structural promoters and/or chemical promoters are included in the composition in Step 1, or by impregnation after Step 2.

26. A process according to claim 25 wherein the structural promoters are selected from Mn, Cr or a mixture thereof.

27. A process according to claim 25 or 26 wherein the chemical promoters are selected from Zn, Mg, Cu, Cr, Ru, Pd, Rh, an alkaline or alkali earth metal.

28. A process according to claim 27 wherein the alkali earth metal is K.

29. A process according to claim 25 wherein the structural and chemical promoters are included in the composition in Step 1, by adding the salt of the promoter to the polar solvent.

30. A process according to any one of claims 19-29 wherein Step 2 is achieved by precipitation from an acidic aqueous solution of Fe ions, manganese nitrate, zinc nitrate, copper nitrate, and potassium nitrate using a basic solution of aqueous NH₃, NaOH or KOH as a precipitating agent.

31. A process according to any one of claims 19-29 where manganese nitrate is not included in the aqueous solution, and the base KOH is used to ensure that the main iron phase is ferrihydrite.

32. A process according to any one of claims 19-31 wherein Step 2 is carried out at a constant or a variable ascending (from 1 to 12) or descending (from about 12 to 1) pH by titrating the acidic solution with the basic solution or vice versa.

33. A process according to claim 32 wherein Step 2 is carried out at a constant pH in the range of 6-9.

34. A process according to any one of claims 19-33 wherein Step 2 is carried out at a high temperature of from 40° C. to 90° C. to ensure that the catalyst precipitates in the ferrihydrite phase.

35. A process according to claim 34 wherein Step 2 is carried out at a high temperature of from 50° C. to 70° C.

36. A process according to any one of claims 19-35 wherein, in Step 4, the catalyst is spraydried at temperatures of about 120° C.

37. A process according to claim 36 wherein the catalyst obtained after spray-drying consists of spherical particles with a size ranging from 40 to 150 μm.

38. A process according to any one of claims 19-37 wherein, in Step 5 or Step 7, the catalyst is calcined in air at a temperature between 250° C. and 500° C. for 5-20 hours.

39. A process according to claim 38 wherein, in Step 5, the catalyst is calcined in air at a temperature of 450° C. for 16 hours.

40. A process according to claim 38 wherein, in Step 7, the catalyst is calcined in air at a temperature of 400° C. for 5 hours.

41. A process according to any one of claims 19-38 wherein, in Step 6, the calcined product is ground and bound with 1 to 30% (by mass of the composition) silica and the resulting mixture is homogenized and dried to obtain a silica bound iron-based catalyst.

42. A process according to any one of claims 19-38 wherein, in Step 7, the dried catalyst is slurried and bound with silica, and calcined to provide a bound iron-based catalyst composition comprising 1 to 30% (by mass of the composition) silica.

43. A process for producing higher parafins, alcohols and olefins selectively, by reacting hydrogen with carbon monoxide in the presence of a catalyst as defined in any one of claims 1-18.
